(19) United States
(12) Patent Application Publication
(10) Pub. No.: US 2005/0024187 A1
(43) Pub. Date: Feb. 3, 2005

(54) System and method for optimizing power usage in a radio frequency communication device

(76) Inventors: Mark J. Kranz, Hallsville, TX (US); James C. Steph, Kilgore, TX (US)

Correspondence Address: John M. Harrington;Kilpatrick Stockton LLP, 1001 West Fourth Street, Winston-Salem, NC, 27101, US

(21) Appl. No.: 10/900,914

(22) Filed: Jul. 28, 2004

Related U.S. Application Data
(60) Provisional application No. 60/490,575, filed on Jul. 28, 2003.

(51) Int. Cl. H04Q 5/22

(52) U.S. Cl. 340/10.33; 340/10.34

(57) ABSTRACT

A radio frequency (RF) communication device is provided comprising means for switching between a low current operating mode and a high current operating mode. The low current operating mode is optimized to conserve power while the RF device is awaiting a wake-up signal from an interrogator. The high current operating mode is optimized to provide antenna matching during backscatter communications so as to maximize the range of backscatter communication between the RF device and the interrogator. Further provided, is a system and method for optimizing power consumption and backscatter range within an RF communication device.

### CROSS REFERENCE TO RELATED APPLICATIONS

The present application claims priority under 35 U.S.C. § 119(e) from U.S. Provisional Patent Application Ser. No. 60/490,575 filed Jul. 28, 2003, entitled “Switchable Bias on Frequency Hopping RFID Tags”, the disclosure of which is incorporated herein by reference.

### FIELD OF THE INVENTION

The present invention relates to systems and methods for increasing communication range and prolonging battery life in a radio frequency communication device. More particularly the present invention relates to systems and methods for improving the overall power usage of a radio frequency identification RFID device.

### BACKGROUND OF THE INVENTION

Remote communication using wireless equipment may rely on radio frequency (RF) technology. One application of RF technology is in locating, identifying, and tracking objects, such as animals, inventory, and vehicles. Other applications of RF technology may include communication of data collected from remote sensors.

RF identification (RFID) tag systems have been developed to facilitate monitoring of remote objects and communication of data collected from remote sensors. As shown in FIG. 1, a basic RF tag system 10 may include three components, an antenna 12, a transceiver with decoder 14, and a transponder (commonly called an RFID tag) 16. In operation, the antenna 12 may emit electromagnetic radio signals generated by the transceiver 14 to activate the RFID tag 16. When the RFID tag 16 is activated, data can be read from or written to the RFID tag 16.

In some applications, the antenna 12 may be a component of the transceiver and decoder 14 to become an interrogator (or reader) 18. The interrogator 18 may activate or “wake up” the RFID tag 16 by radiating energy to the tag in an on/off pattern encoded in some time varying manner. When an RFID tag 16 passes through the electromagnetic radio waves 20, the RFID tag 16 detects the signal 20 and is activated. An example of one manner commonly used to activate an RFID tag is biphase encoding. When the interrogator 18 is done talking to the RFID tag 16, the interrogator 18 may then go to a continuous broadcast of energy that the RFID tag 16 uses to communicate information to the interrogator via backscatter methodologies. Data encoded in the RFID tag 16 may be communicated to the interrogator 18 by a data signal 22 through an antenna 23. The RFID tag 16 may modulate its antenna and put a subcarrier on the interrogator's backscattered carrier signal that could later be stripped off and demodulated. The subcarrier may use a time varying amplitude shifting modulation technique such as biphase modulation to encode the data into the subcarrier signal.

RFID tag communication systems may include systems where the RFID tags return data at a specific frequency associated with each RFID tag. For example, an interrogator may transmit a signal at one frequency, and each RFID tag can modulate the amplitude of its signal at a frequency separate from the frequency of any other RFID tag in the system. Such systems can allow the interrogator to simultaneously differentiate information received from multiple RFID tags. Further, the RFID tags may be configured to allow a tag to communicate at one of several frequencies and to adaptively avoid interference with other tags that may be communicating on an identical frequency. While an RFID tag may adaptively change the frequency at which it is communicating, the means for communicating information still relies on a method of modulating the amplitude of a signal in some time varying fashion to encode data in the signal.

In what is known as a “semi-passive” tag, the tag uses battery power to listen for the “wake-up” signal from the interrogator. Once the interrogator and tag have established communication, the tag uses further battery power to modulate its antenna. By communicating with the interrogator through the antenna modulations rather than actively transmitting an RF signal, the tag uses significantly less power than an actively transmitting tag. This configuration minimizes power consumption, as power is only used to listen for the “wake-up” signal and modulate the antenna to communicate information back to the interrogator. However, the actual power needed during the listening mode differs greatly from the power needed during the modulation or backscatter mode.

The listening mode requires little power because the tag is essentially idle and waiting for a signal from the interrogator. A small current is required to provide a reference voltage to the comparator for use in deciphering RF signals received from the antenna.

During backscatter mode, more power is required to provide a bias current to the diodes, which decreases their equivalent RF resistance causing them to be better matched to the antenna impedance. This increases the resonance response of the antenna causing more RF energy to be reflected back to the interrogator. This increase in backscattered energy increases the range from which the tag can be read.

Unfortunately, in order to bias the diodes in an optimum fashion for backscatter purposes, a small resistor must be used for the load. This means that when the tag is listening for a signal, the rectified signal input from the antenna will inefficiently couple to the comparator circuit. For an ideal listening circuit the system should have a very low current drain on the rectified signal. However, this results in poor backscatter range.

Current tag configurations face the challenge attempting to optimize a system with two competing power requirements. The current solution is to bias the diode switches at some point that is not optimum for either wake up or backscatter modes, but rather, somewhere in between. Often the tag is optimized for power consumption during the listening mode, which decreases backscatter range, but prolongs battery life.

It would, therefore, be desirable to provide a system and method with two distinct operating modes capable of switching the load/bias between a high impedance load suitable for the listening mode and a low impedance load offering increased backscatter range, such that both backscatter range and battery life conditions can be optimized. It is to these perceived needs that the present invention is directed.

### SUMMARY OF THE INVENTION

In a first aspect of the present invention, an RF transponder is provided comprising an antenna operable to receive RF signals from an interrogator and communicate information back to said interrogator, a power source, and a signal processing circuit in communication with said antenna and said power source, comprising means for switching between a low current operating mode and a high current operating mode.

In one embodiment of the present invention, the means for switching between a low current operating mode and a high current operating mode comprises a switchable resistor operable to be connected or disconnected to the circuit. The low current operating mode is defined by a high impedance voltage within the circuit and the high current operating mode is defined by a low impedance voltage within the circuit.

In another embodiment of the present invention, the signal processing circuit of the RF transponder comprises two resistors, a first resistor comprising a first resistive value, and a second resistor comprising a second resistive value smaller than the first resistive value. In a preferred embodiment of the present invention, the first resistive value is at least 10³ times greater than the second resistive value. In another preferred embodiment of the present invention, the resistive value of the first resistor is selected to optimize power consumption by providing a high impedance voltage to the system, and the resistive value of the second resistor is selected to optimize backscatter range by matching the impedance of the circuit to approximately that of the antenna.

In another embodiment of the present invention, the signal processing circuit of the RF transponder further comprises a comparator and a microcontroller. Preferably, the switching means is integrated into the microcontroller and said microcontroller engages the second resistor based on signals received from the comparator to switch between low current mode and high current mode. In a further embodiment of the present invention, the antenna of the RF transponder communicates information back to the interrogator through backscatter methodologies.

In another aspect of the present invention, an RF communication system is presented comprising a transponder as described above, an interrogator, and a sensor, wherein the sensor is in electrical communication with the RF transponder. The system is further defined wherein the RF transponder operates in the low current mode until a signal from the interrogator is received by the antenna, and upon reception of a signal, the RF transponder switches to a high current operating mode and communicates information received from the sensor to the interrogator through backscatter methodologies.

In another aspect of the present invention, the low current operating mode is defined by a high impedance voltage within the circuit, and the high current operating mode is defined by a low impedance voltage within the circuit. Further, the signal processing circuit may comprise two resistors, a first resistor comprising a first resistive value, and a second resistor comprising a second resistive value smaller than the first resistive value. In a preferred embodiment of the present invention, the first resistive value is at least 10³ times greater than the second resistive value.

In a further aspect of the present invention, a method for optimizing power consumption in an RF transponder is provided comprising, providing an RF transponder comprising an antenna and a power source, and providing a signal processing circuit in communication with said antenna and said power source, comprising means for switching between a low current operating mode and a high current operating mode in response to a signal received from an interrogator. The signal processing circuit operates in said low current operating mode to conserve power while awaiting a wake-up signal from an interrogator, and when a wake-up signal is received by the antenna and processed by the signal processing circuit, the signal processing circuit switches to said high current operating mode. The low current operating mode is optimized for receiving a wake-up signal from the interrogator and the high current operating mode is optimized for communicating information to the interrogator through backscatter methodologies.

Features of a system and method for optimizing power consumption in an RF communication device of the present invention may be accomplished singularly, or in combination, in one or more of the embodiments of the present invention. As will be appreciated by those of ordinary skill in the art, the present invention has wide utility in a number of applications as illustrated by the variety of features and advantages discussed below.

A system and method for optimizing power consumption in an RF communication device of the present invention provides numerous advantages over prior RF communication device configurations. For example, the present invention advantageously provides optimization of backscatter range while also providing the ability to optimize power consumption during listening mode.

As will be realized by those of skill in the art, many different embodiments of a system and method for optimizing power consumption in an RF communication device according to the present invention are possible. Additional uses, objects, advantages, and novel features of the invention are set forth in the detailed description that follows and will become more apparent to those skilled in the art upon examination of the following or by practice of the invention.

### BRIEF DESCRIPTION OF THE DRAWINGS

FIG. 1 is a diagram showing communication between an interrogator and one RF tag.

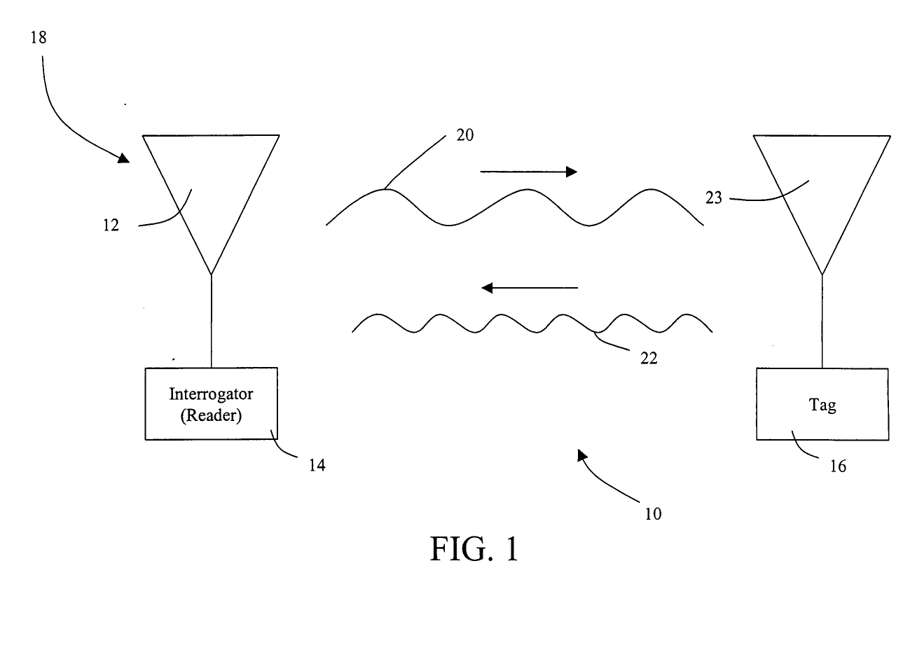

FIG. 2 is a diagram of a typical RFID tag system comprising one interrogator and a plurality of tags.

FIG. 3 is a diagram of an RF communication system comprising an interrogator and one RF tag.

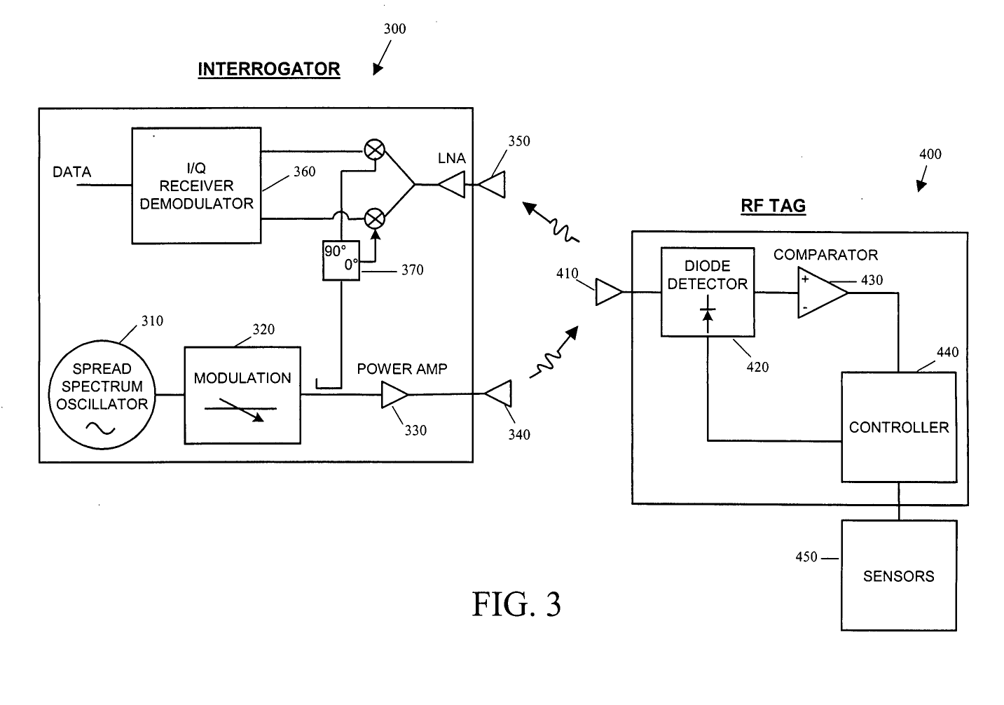

FIG. 4 is a schematic of a RFID tag according to one embodiment of the present invention showing an additional resistor, R_{switch} engaged to provide a low impedance load to increase the bias current during backscatter mode.

### DETAILED DESCRIPTION

In a first aspect of the present invention, a radio frequency (RF) communication device is provided comprising means for switching between a low current operating mode and a high current operating mode. The low current operating mode is optimized to conserve power while the RF device is awaiting a wake-up signal from an interrogator. The high current operating mode is optimized to provide antenna matching during backscatter communications so as to maximize the range of backscatter communication between the RF device and the interrogator.

In a preferred embodiment of the present invention, the remote RF communication device comprises a radio frequency identification tag. The description of the preferred embodiments of the present invention will be discussed with reference to a RF tag and RF transponder as the RF communication device.

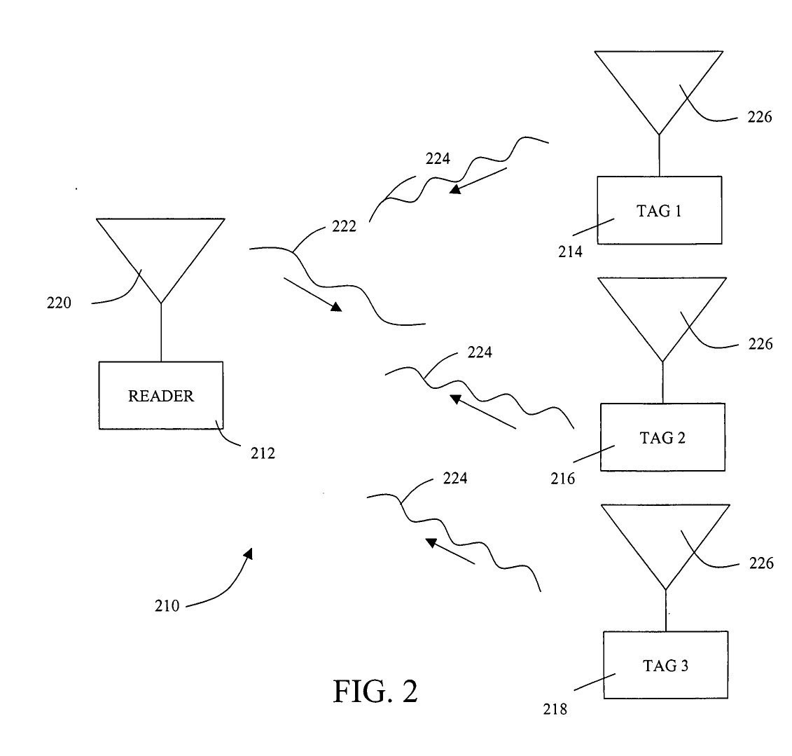

In one aspect of the present invention, the RF communication system comprises an interrogator and at least one RF communication device comprising an RF tag. Referring now to FIG. 2, a diagram of one embodiment of a communication system of the present invention is illustrated. The communication system 210 comprises an interrogator 212 and a plurality of remote communication devices 214, 216, and 218.

Each remote communication device 214, 216, and 218 within the system 210 comprises: a remote communication device antenna 226 operable to receive and backscatter a carrier signal 222. The backscattered carrier signal 224 comprises the carrier signal and a secondary signal with data encoded therein. The remote communication devices 214, 216, and 218 further comprise a signal processing circuit coupled to the remote communication device antenna 226. The signal processing circuit comprises at least one encoding circuit operable to encode binary data into the backscattered carrier signal.

The interrogator 212 comprises an antenna 220 operable to receive a plurality of backscattered carrier signals 224 backscattered from the plurality of remote communication devices 214, 216, and 218. The interrogator 212 further comprises a receiving circuit coupled to the antenna 220 operable to extract data from each of the backscattered carrier signals 224. Although three remote communication devices 214, 216, and 218 are illustrated, the system 210 may comprise any number of remote communication devices.

In a further embodiment of the present invention, the interrogator 212 may further comprise a transmitting circuit coupled to the antenna 220, wherein the transmitting circuit is operable to transmit a carrier signal 222 to the plurality of remote communication devices 214, 216, and 218. In another embodiment, the antenna 220 may comprise a transmitting antenna coupled to a transmitting circuit and a receiving antenna coupled to the receiving circuit.

In another embodiment, the remote communication device antenna 226 and the signal processing circuit of the remote communication devices may be configured to generate a supply voltage from the carrier signal.

In another embodiment of the communication system 210, the remote communication devices 214, 216, and 218 may further comprise a sensor coupled to the signal processing circuit, wherein the signal processing circuit is further operable to receive a sensor signal from the sensor, encode the sensor signal, and include the encoded sensor signal in the secondary signal of the backscattered carrier signal 224.

As used herein, a sensor includes any device that senses either the absolute value of or a change in a physical quantity such as, but not limited to, temperature, pressure, intensity of light, and acceleration. For example, any pressure sensor known in the art may be used in the practice of the present invention as long as it may be functionally connected to a remote communication device. In an embodiment, a pressure sensor may comprise a piezoelectric pressure sensor in which a voltage is applied across a diaphragm coated with piezo crystals. Those skilled in the art will recognize other sensing means that may be employed in the various embodiments of the present invention without altering the spirit or scope of the present invention.

The devices, systems and methods of embodiments of the present invention may employ many standard RFID hardware technologies known to those of ordinary skill in the art to which the features of the embodiments of the present invention have been added. Hardware methodologies can vary greatly within the scope of the present invention, but the principle of switching between two distinct power consumption modes can be applied to numerous hardware configurations.

For example, commercially available microcontrollers such as, but not limited to, an MSP 430 series of microcontrollers from Texas Instruments include an on board ring or RC oscillator that can be adjusted in fine steps. The microcontroller can act as the switch for the additional resistor (R_{switch}) of the present invention. By using pre-existing hardware, the systems and methods of the present invention may be employed without much, if any, additional cost to the system.

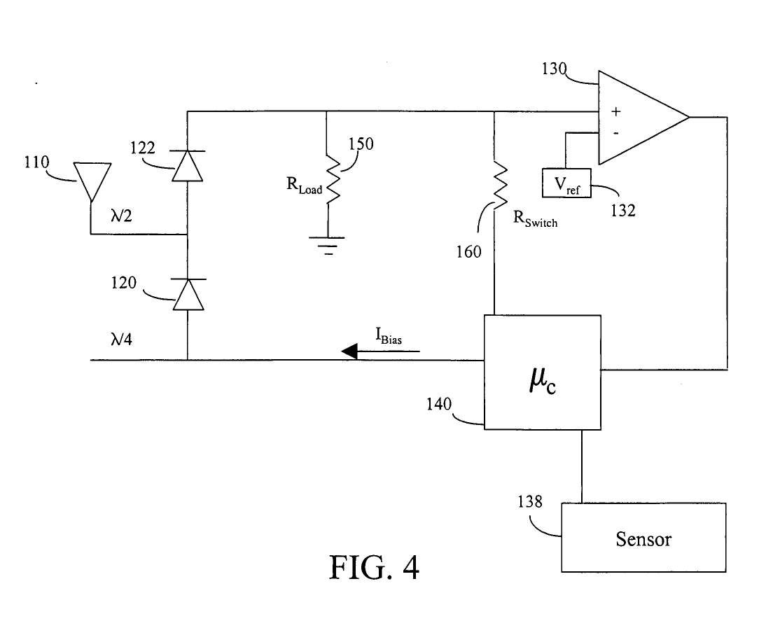

Referring to FIG. 4, showing a simplified schematic illustrating the concepts of an embodiment of the present invention, the RF communication device comprises an antenna 110, a power source, and signal processing circuitry. The signal processing circuitry comprises a comparator 130 and a microcontroller 140. The comparator 130 compares signals received by the antenna 110 to a reference signal 132 and feeds the results to the microcontroller 140. The microcontroller 140 controls the computing and short-term memory functions on the tag. Further, the microcontroller 140 accepts signals from the sensor 138 and encodes the signals for communication back to the interrogator through antenna 110 backscatter methodologies.

In a preferred embodiment of the present invention, the means for switching between a low current operating mode and a high current operating mode comprises the addition of a low load resistor 160 (R_{switch}) and a switch for engaging and disengaging the low load resistor to the input of the microcontroller. When the signal processing circuit on the RF communication device detects an incoming signal from the antenna, the switch turns the low load resistor 160 “on” thereby shunting the primary resistor 150 (R_{load}) and providing more current to the system.

In a preferred embodiment of the present invention, the low current operating mode provides a low current voltage to the system. This low current voltage is achieved through a high impedance provided by the high load resistor 150 (R_{load}). This provides the necessary voltage to the comparator to effect the detection and comparison of an incoming RF signal from the antenna 110. An RF communication device may be “idle” in low current operating mode for significant lengths of time before an interrogator signal is received. By operating in the low current mode during this time, the RF communications device can effectively await instructions from the interrogator while using a minimal amount of power. When a signal is detected by the signal processing circuit, the circuit switches to high current mode.

In a preferred embodiment of the present invention the low load resistor 160 is selected such that the high current operating mode produces a high bias current (I_{bias}) to the system, and particularly to the antenna. The desired effect is a high matching of the antenna such that the impedance of the circuit closely approximates that of the antenna. By providing a low source impedance and therefore a high load to the antenna, such that the source impedance matches the antenna impedance, the backscatter range of the RF communication device may be maximized for the given system.

In one embodiment of the present invention, provided to illustrate an exemplary configuration, the RF tag comprises a power source of 2.8 volts. In this configuration, prior art systems would have a standard load resistor of approximately 1 Mega ohms to allow for relatively good backscatter range up to 10 Mega ohms to reduce power consumption during listening mode. In either case, the backscatter range could not be optimized due to the draw on the battery during listening mode. The present invention replaces this configuration with a high load resistor 150 (R_{load}) of between about 1 and about 10 Mega ohms, and the switchable low load resistor 160 (R_{switch}) of about 1000 ohms. In the present configuration, power consumption can be minimized through the high load resistor, and the low load resistor can provide antenna matching during backscatter.

In this example, the difference in resistance between R_{load} and R_{switch} is approximately 10³ to 10⁴. This allows the RF tag a broad range between the low current and high current operating modes to provide significant power savings during listening mode, and nearly perfect antenna matching achieved during backscatter mode. Through this configuration and technique, the backscatter range can typically be doubled as compared to a traditional RF tag optimized for power consumption. In an exemplary embodiment of this feature, a prior art system optimized for power consumption employed a 1 Mega ohm load resistor. This system was able to backscatter about 5 feet when introduced to a 1 megawatt interrogator. To contrast, a system of the present invention employed a 1 Mega ohm load resistor and a 2.5 kilo-ohm switchable resistor, and was able to backscatter 15 feet with no loss in reception. This reflects a three-fold increase in backscatter range as compared to a similar prior art system.

The precise values for R_{load} and R_{switch} will be appreciated by those skilled in the art for a given RF transponder, and will be designed based on the needs of the system. However, the principles taught herein are applicable to RF transponders that would benefit by having two operating modes comprising different optimized power requirements. As previously discussed, the ideal system would provide a high resistive value for R_{load} so as to minimize power usage during listening mode, and an appropriate resistive value for R_{switch} so as to provide antenna matching and maximize backscatter range.

Although the present invention has been described with reference to particular embodiments, it should be recognized that these embodiments are merely illustrative of the principles of the present invention. Those of ordinary skill in the art will appreciate that the apparatus and methods of the present invention may be constructed and implemented in other ways and embodiments. Accordingly, the description herein should not be read as limiting the present invention, as other embodiments also fall within the scope of the present invention.

1. An RF transponder, comprising:
an antenna operable to receive RF signals from an interrogator and communicate information back to said interrogator;
a power source; and,
a signal processing circuit in communication with said antenna and said power source, comprising means for switching between a low current operating mode and a high current operating mode.

2. The RF transponder of claim 1, wherein the means for switching between a low current operating mode and a high current operating mode comprises a switchable resistor operable to be connected or disconnected to the circuit.

3. The RF transponder of claim 1, wherein the low current operating mode is defined by a high impedance voltage within the circuit.

4. The RF transponder of claim 1, wherein the high current operating mode is defined by a low impedance voltage within the circuit.

5. The RF transponder of claim 1, wherein the signal processing circuit comprises two resistors, a first resistor comprising a first resistive value, and a second resistor comprising a second resistive value smaller than the first resistive value.

6. The RF transponder of claim 5, wherein the first resistive value is at least 10³ times greater than the second resistive value.

7. The RF transponder of claim 1, wherein the resistive value of the first resistor is selected to optimize power consumption by providing a high impedance voltage to the system.

8. The RF transponder of claim 1, wherein the resistive value of the second resistor is selected to optimize backscatter range by matching the impedance of the circuit to approximately that of the antenna.

9. The RF transponder of claim 1, wherein the signal processing circuit further comprises a comparator and a microcontroller.

10. The RF transponder of claim 9, wherein the switching means is integrated into the microcontroller and said microcontroller engages the second resistor based on signals received from the comparator to switch between low current mode and high current mode.

11. The RF transponder of claim 1, wherein the antenna communicates information back to the interrogator through backscatter methodologies.

12. An RF communication system comprising the RF transponder of claim 1, an interrogator, and a sensor, wherein the sensor is in electrical communication with the RF transponder.

13. The RF communication system of claim 12, wherein said RF transponder operates in the low current mode until a signal from the interrogator is received by the antenna, upon reception of a signal, the RF transponder switches to a high current operating mode and communicates information received from the sensor to the interrogator through backscatter methodologies.

14. The RF communication system of claim 12, wherein the low current operating mode is defined by a high impedance voltage within the circuit.

15. The RF communication system of claim 12, wherein the high current operating mode is defined by a low impedance voltage within the circuit.

16. The RF communication system of claim 12, wherein the signal processing circuit comprises two resistors, a first resistor comprising a first resistive value, and a second resistor comprising a second resistive value smaller than the first resistive value.

17. The RF communication system of claim 16, wherein the first resistive value is at least 10³ times greater than the second resistive value.

18. A method for optimizing power consumption in an RF transponder comprising:
providing an RF transponder comprising an antenna and a power source; and, providing a signal processing circuit in communication with said antenna and said power source, comprising means for switching between a low current operating mode and a high current operating mode in response to a signal received from an interrogator;
wherein the signal processing circuit operates in said low current operating mode to conserve power while awaiting a wake-up signal from an interrogator, and when a wake-up signal is received by the antenna and processed by the signal processing circuit the signal processing circuit switches to said high current operating mode.

19. The method of claim 18, wherein the low current operating mode is optimized for receiving a wake-up signal from the interrogator.

20. The method of claim 18, wherein the high current operating mode is optimized for communicating information to the interrogator through backscatter methodologies.
